(19) United States
(12) Patent Application Publication
(10) Pub. No.: US 2007/0066744 A1
(43) Pub. Date: Mar. 22, 2007

(54) Tire with tread containing tin coupled amine functionalized polybutadiene and nanostructured inversion carbon black

(76) Inventors: Marc Weydert, Strassen (LU); Maurice Peter Catharina Jozef Klinkenberg, Gosseldange (LU); Georges Marcel Victor Thielen, Schouweiler (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/232,569

(22) Filed: Sep. 21, 2005

(51) Int. Cl. B60C 1/00

(52) U.S. Cl. 524/493; 524/571; 524/515; 525/333.9; 525/342

(57) ABSTRACT

This invention relates to a tire with a circumferential rubber tread of a rubber composition containing a tin coupled amine functional polybutadiene and reinforcement comprised of nanostructured inversion carbon black.

### FIELD OF THE INVENTION

This invention relates to a tire with a circumferential rubber tread of a rubber composition containing a tin coupled amine functional polybutadiene and reinforcement comprised of nanostructured inversion carbon black.

### BACKGROUND OF THE INVENTION

Rubber reinforcing carbon blacks are often used for reinforcement of rubber compositions used for various rubber based components of vehicular tires. Such rubber reinforcing carbon blacks are often referred to by their ASTM designations and such rubber reinforcing carbon blacks are referenced in, for example, The Vanderbilt Rubber Handbook, 1978 edition, Page 417.

Inversion carbon blacks have also been suggested for use in reinforcement of rubber compositions and are reported as being differentiated from the above referenced more conventional rubber reinforcing carbon blacks in a sense of having a particle size distribution which contains a small proportion of particles with large diameters which is said to lead to an improved resistance to abrasion for rubber compositions. For example, see U.S. Pat. Nos. 6,056,933 and 6,251,983 as references which are incorporated herein in their entirety.

Nanostructured inversion carbon blacks, are reported as being improved inversion carbon blacks, for use in reinforcement of rubber compositions are also presented in the above U.S. Pat. Nos. 6,056,933 and 6,251,983, as well as a method of preparation, which are described in terms of their particle size distribution according to an absolute slope (AS) restriction, CTAB value range, and 24MP-DBP value range as reported in said U.S. Pat. Nos. 6,056,933 and 6,251,983. Such carbon blacks are referred to herein as “nanostructured inversion carbon blacks”.

Pneumatic tires conventionally contain a circumferential rubber tread with a running surface for the tire of a rubber composition comprised of a conjugated diene based elastomer such as, for example mixtures of cis 1,4-polybutadiene rubber and styrene/butadiene elastomers which may also contain a cis 1,4-polyisoprene rubber.

Variations of polybutadiene elastomers are functionalized polybutadienes in a sense of having of functional terminal ends and/or functional vinyl substituents which are available to functionally react, or interact, with other materials where desired. Amine functionalized polybutadiene elastomers, particularly end, or terminal, amine functionalized polybutadiene elastomers have been prepared, for example, by polymerizing 1,3-butadiene monomer in the presence of a catalyst and an amine functionalized initiator compound. For Example, see U.S. Pat. Nos. 6,211,321 and 6,111,045.

Further, such amine functionalized polybutadienes may be tin-coupled by, for example, by coupling the amine functionalized polybutadiene rubber with a tin coupling agent at or near the end of the polymerization used in synthesizing the polybutadiene. In the coupling process, live polymer chain ends react with the tin coupling agent (e.g. tin tetrachloride) thereby coupling polymer chains together and substantially increasing the overall molecular weight and therefore increasing its Mooney (ML1+4), (100° C.), viscosity value. For instance, up to four live chain ends can react with tin tetrahalides, such as tin tetrachloride, to thereby couple the four polymer chains together in perhaps what might be considered a star shaped configuration. For example, see U.S. Pat. No. 5,115,006.

The coupling of such tin coupled, terminal amine functionalized polybutadienes tends to at least partially break down during high shear mixing of a rubber composition which contains such tin coupled functionalized polybutadiene elastomer at an elevated temperature (e.g. 130° C. to 175° C.) in a manner that the aforesaid Mooney viscosity of the polybutadiene elastomer within the rubber composition is thereby reduced to render it more easily processable in an internal rubber mixer. A particular benefit in utilizing such amine functionalized polybutadiene elastomer in its coupled state in a rubber composition is seen in the sense of creating active sites on the chain ends of the polybutadiene elastomer, as the uncoupling occurs in situ within the rubber composition, which beneficially combine with the rubber reinforcing carbon black particles to form an enhanced rubber reinforcement network within the associated rubber composition, a phenomenon believed to be well known to those having skill in such art.

In the description of this invention, the term “phr” is used to designate parts by weight of a material per 100 parts by weight of elastomer. The terms “rubber” and “elastomer” may be used interchangeably unless otherwise indicated. The terms “vulcanized” and “cured” may be used interchangeably, as well as “unvulcanized” or “uncured”, unless otherwise indicated. The term “Tg”, if used, refers to glass transition temperature determined by DSC (differential scanning calorimeter) at a rate of temperature rise of 20° C. per minute, unless otherwise specified (e.g. 10° C. rise per minute), well known by those having skill in such art. (ASTM D3418-99). The glass transition temperatures are typically inflection point based, unless otherwise specified such as, for example, onset glass transition temperatures

### SUMMARY AND PRACTICE OF THE INVENTION

In accordance with this invention, a tire is provided having a tread of a rubber composition comprised of, based upon parts by weight per 100 parts by weight of elastomer (phr),

(A) 100 phr of elastomers comprised of:
(1) about 5 to about 50, alternately from about 15 to about 50, phr of polybutadiene elastomer comprised of a tin coupled amine end functionalized polybutadiene elastomer, and
(2) about 50 to about 95, alternately from about 50 to about 85, phr of at least one additional conjugated diene-based elastomer selected from polymers of isoprene, copolymers of isoprene and 1,3-butadiene and copolymers of styrene and at least one of isoprene and 1,3-butadiene; and

(B) about 35 to about 120 phr of rubber reinforcing filler comprised of nanostructured inversion carbon black.

In further accordance with this invention, said nanostructured inversion carbon black has:

(A) a particle size distribution curve with an absolute slope (AS) of less than 400,000 nm³, alternately less than 200,000 nm³, and alternately greater than 100,000 nm³, the absolute slope (AS) as determined (as described in U.S. Pat. No. 6,056,933) from measured aggregate size distribution using the following formula:

$$AS = \frac{{\sum }_{i = 1}^{k} {{H}_{i} ( {x}_{i} - \overline{x} )}^{3}}{{\sum }_{i = 1}^{k} {H}_{i}}$$

wherein Hᵢ denotes the frequency at which the particle diameter xᵢ occurs and x is the particle diameter of the aggregate, whose weight corresponds to the average particle weight of the carbon black aggregate, the summation being carried out in the range of 1 to 3000 nm in equidistant spacing for each nanometer,

(B) a CTAB value (ASTM D-3765) in a range of from about 20 to about 190, alternately from about 60 to about 140, m²/g, and

(C) a 24M4-DBP absorption value (ASTM D-3493) in a range of from about 40 to about 140 cc/100 g.

In additional accordance with this invention, said about 35 to about 120 phr of rubber reinforcing filler is comprised of:

(A) about 30 to about 100 phr of said nanostructured inversion carbon black, and

(B) about 5 to about 90 phr of at least one rubber reinforcing carbon black (classical rubber reinforcing carbon black) having a combination of Iodine adsorption value (ASTM D-1510) in a range of from about 90 to about 150 g/kg and a DBP (dibutylphthate) value (ASTM D-2414) in a range of from about 100 to about 200 cc/100 g.

In further accordance with this invention, said about 35 to about 120 phr of rubber reinforcing filler is comprised of:

(A) about 35 to about 110 phr of said nanostructured inversion carbon black, and

(B) about 10 to about 85 phr of precipitated silica (synthetic amorphous silica aggregates) which contains hydroxyl groups (e.g. silanol groups) thereon, and

(C) optionally a coupling agent for said precipitated silica having a moiety reactive with said hydroxyl groups (e.g. silanol groups) on said precipitated silica and another different moiety interactive with said polybutadiene elastomer and said additional conjugated diene-based elastomer.

In additional accordance with this invention, said about 35 to about 120 phr of rubber reinforcing filler is comprised of:

(A) about 35 to about 110 phr of rubber reinforcing carbon black comprised of:
(1) about 30 to about 105 phr of said nanostructured inversion carbon black, and
(2) about 5 to about 80 phr of classical rubber reinforcing carbon black having said combination of Iodine adsorption and DBP values, and

(B) about 10 to about 85 phr of said precipitated silica, and

(C) optionally a coupling agent for said precipitated silica having a moiety reactive with said hydroxyl groups (e.g. silanol groups) on said precipitated silica and another different moiety interactive with said polybutadiene elastomer and said additional conjugated diene-based elastomer.

A representative example of said nanostructured inversion carbon black is Ecorax 1720™ from Degussa. Inversion carbon blacks, including nanostructured inversion carbon blacks, and preparation thereof, are reported in said U.S. Pat. No. 6,251,983 in terms of said SA, CTAB and 24M4-DBP characterization as exemplified as EB 171 therein.

In a paper entitled “The Effect of Filler-Filler and Filler-Elastomer Interaction on Rubber Reinforcement” by J. Frohlich, W. Neidermeir and H. Luginsland (year 2004) of Composites: Part A from “Science Direct” at www.sciencedirect.com, EB171 referred to as a nanostructured black, as differentiated from an N234 ASTM black, in that:
The novel nanostructured blacks, produced by a physical modification of the carbon black production process, are characterized by a high surface roughness and large number of high-energy patches, or sites, equivalent to a high surface activity.
The origin of the roughness found at the carbon black surface is explained by a reduced lateral extension of the nanocrystallites linked by a high degree of geometrical disarrangement.

In said U.S. Pat. No. 6,056,933, it is mentioned that the absolute slope of inversion carbon blacks (as distinguished from the absolute slope of nanostructured carbon blacks), according to patent publication DE 195,565 is higher than 400,000 nm³, and the measurement of size distribution for the for the absolute slope (AS) for the nanostructured inversion carbon black is mentioned in the aforesaid U.S. Pat. No. 6,251,983. It is mentioned that ASTM D-1765 might be used for determining the average particle diameter of the carbon black aggregate.

A significant aspect of the use of the tin coupled amine functionalized polybutadiene elastomer in combination with the nanostructured inversion carbon black in the rubber composition for a tire tread of this invention, as hereinbefore discussed, in the sense of the tin coupled elastomer promoting a better hysteresis property (reduced hysteresis) for the associated rubber composition in combination with the nanostructured inversion carbon black also promoting a better hysteresis property (reduced hysteresis) because of its more distorted surface structure in a sense of the surface being significantly rougher in nature (having a rougher surface texture) than conventional, or classical, rubber reinforcing carbon blacks.

As hereinbefore discussed, classical rubber reinforcing carbon blacks, such as those used for tire treads, may have DBP (dibutyl phthalate) values (ASTM D2414) and Iodine values (ASTM D1510) in a range of, for example, about 100 to about 200 cc/100 g and in a range of about 90 to about 150 g/kg. Representative of such highly reinforcing carbon blacks are, for example, carbon blacks having ASTM designations N 110, N121 and N234, which are carbon blacks often used for tire tread rubber compositions.

In practice, the tin-coupled amine end functionalized polybutadiene elastomer may be prepared by reacting “living” amine end functionalized polybutadiene having lithium end groups with a tin halide, such as tin tetrachloride. The coupling step might be carried out as a batch process, although it may be carried out as a continuous process.

In practice, the tin coupling agent employed may normally be a tin tetrahalide, such as tin tetrachloride, tin tetrabromide, tin tetrafluoride or tin tetraiodide, with tin tetrachloride usually being preferred. However, tin trihalides can also optionally be used where appropriate. In cases where tin trihalides are utilized, a coupled polymer having a maximum of three arms results. To induce a higher level of branching, tin tetrahalides are normally preferred.

In practice, the tin coupled amine end functionalized polybutadiene elastomer is comprised of a tin atom having about four (where a tin tetrahalide is used) or about three (there a tin trihalide is used) polybutadiene arms covalently bonded thereto. The tin-coupled amine functionalized polybutadiene elastomer may be asymmetrical in a sense that the individual polybutadiene portions of the amine functionalized polybutadiene arms may be of significantly different molecular weights ranging, for example, from about 20,000 to about 100,000 (or even higher) number average molecular weights.

A representative example of a tin coupled, amine end functionalized polybutadiene elastomer is BR1250H™ rubber from the Nippon Zeon Company.

Representative of additional conjugated diene-based elastomers for use in the tire tread rubber composition, (in addition to said tin coupled amine end functionalized polybutadiene) are, for example, cis 1,4-polyisoprene (natural and synthetic), cis 1,4-polybutadiene, styrene/butadiene copolymers (aqueous emulsion polymerization prepared and organic solvent solution polymerization prepared), isoprene/butadiene copolymers, styrene/isoprene/butadiene terpolymers, high vinyl polybutadiene rubber containing from about 30 to about 90 percent vinyl 1,2-groups and 3,4-polyisoprene elastomer (with the 3,4-polyisoprene elastomer preferably being used in amounts in a range of from about 5 about 20 phr in the rubber composition).

The synthetic amorphous silica, preferably precipitated silica, generally employed in this invention, are those obtained by the acidification of a soluble silicate, e.g., sodium silicate, usually in the presence of an electrolyte, and may include co-precipitated silica and a minor amount of aluminum, as is considered herein to be well known to those having skill in such art.

Such silicas might usually be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, Page 304 (1930).

The silica may also be typically characterized, for example, by having a dibutylphthalate (DBP) absorption value in a range of about 50 to about 400 cc/100 g, and more usually about 100 to about 300 cc/100 g.

Various commercially available precipitated silicas may be considered for use in this invention such as, only for example herein, and without limitation, silicas from PPG Industries under the Hi-Sil trademark with designations Hi-Sil 210, Hi-Sil 243, etc; silicas from Rhodia as, for example, Zeosil 1165MP, silicas from Degussa AG with, for example, designations VN2 and VN3, as well as other grades of silica, particularly precipitated silicas, which can be used for elastomer reinforcement.

In practice, said coupling agent may be, for example,

(A) a bis-(3-trialkoxysilylalkyl) polysulfide such as, for example, a bis-(3-triethoxysilylpropyl) polysulfide, having an average of from 2 to about 4 and more preferably an average of from 2 to about 2.6 or an average of from about 3.4 to about 4, connecting sulfur atoms in its polysulfidic bridge, or

(B) a combination of a bis-(3-triethoxysilylpropyl) polysulfide having an average of from about 2 to about 2.6 connecting sulfur atoms in its polysulfidic bridge and a bis-(3-triethoxysilylpropyl) polysulfide having an average of from about 3.4 to about 4 connecting sulfur atoms in its polysulfidic bridge, wherein said polysulfide having an average of from 2 to about 2.6 connecting sulfur atoms in its polysulfidic bridge (to the exclusion of such polysulfide having an average of from 3 to 4 connecting sulfur atoms in its polysulfidic bridge) is blended with said rubber composition in the absence of sulfur and sulfur vulcanization accelerator and wherein said polysulfide having an average of from about 3.4 to about 4 connecting sulfur atoms in its polysulfidic bridge is thereafter blended with said rubber composition in the presence of sulfur and at least one sulfur vulcanization accelerator, or

(C) an organoalkoxyrnercaptosilane composition of the general Formula (I) represented as:
(X)ₙ(R⁷O)₃₋ₙ—Si—R₈—SH (I)

wherein X is a radical selected from a halogen, namely chlorine or bromine and preferably a chlorine radical, and from alkyl radicals having from one to 16, preferably from one through 4, carbon atoms, preferably selected from methyl, ethyl, propyl (e.g. n-propyl) and butyl (e.g. n-butyl) radicals; wherein R⁷ is an alkyl radical having from 1 through 18, alternately 1 through 4, carbon atoms preferably selected from methyl and ethyl radicals and more preferably an ethyl radical; wherein R₈ is an alkylene radical having from one to 16, preferably from one through 4, carbon atoms, preferably a propylene radical; and n is an average value of from zero through 3, preferably zero, and wherein, in such cases where n is zero or 1, R⁷ may be the same or different for each (R⁷O) moiety in the composition, or

(D) an organoalkoxymercaptosilane in a form of the said organoalkoxymercaptosilane (of the general Formula I) having its mercapo moiety capped with a moiety which can uncap its mercapto group during selected processing of the rubber composition, for example and depending upon the nature of the capping moiety and rubber composition itself, upon heating to an elevated temperature in the presence of an amine.

Representative examples of various organoalkoxymercaptosilanes are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane.

Such organoalkoxymercaptosilanes may be capped with various moieties as discussed above.

A representative example of a capped organoalkoxymercaptosilane coupling agent useful for this invention is a liquid 3-octanoylthio-1-propyltriethoxysilane as an NXT™ Silane from the GE Silicones Company.

The coupling agent may, for example, be added directly to the elastomer mixture or may be added as a composite of precipitated silica and such coupling agent formed by treating a precipitated silica therewith or by treating a colloidal silica therewith and precipitating the resulting composite.

For example, said silica (e.g. precipitated silica), or at least a portion of said silica, may be pre-treated prior to addition to said elastomer(s):

(A) with an alkylsilane of the general Formula (II), or

(B) with said bis(3-triethoxysilylpropyl) polysulfide having an average of from about 2 to about 4 connecting sulfur atoms in its polysulfidic bridge, or

(C) with said organomercaptosilane of the general Formula (I), or

(D) with a combination of said alkylsilane of general Formula (I) and said bis(3-triethoxysilylpropyl) polysulfide having an average of from about 2 to about 4 connecting sulfur atoms in its polysulfidic bridge, or

(E) with a combination of said alkylsilane of general Formula (II) and said organomercaptosilane of general Formula (I);

wherein said alkylsilane of the general Formula (I) is represented as:
Xₙ—Si—R₆₍₄₋ₙ₎ (II)

wherein R₆ is an alkyl radical having from 1 to 18 carbon atoms, preferably from 1 through 4 carbon atoms; n is a value of from 1 through 3; X is a radical selected from the group consisting of halogens, preferably chlorine, and alkoxy groups selected from methoxy and ethoxy groups, preferably an ethoxy group.

A significant consideration for said pre-treatment of said silica is to reduce, or eliminate, evolution of alcohol in situ within the rubber composition during the mixing of the silica with said elastomer such as may be caused, for example, by reaction of such coupling agent contained within the elastomer composition with hydroxyl groups (e.g. silanol groups) contained on the surface of the silica.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

Typical amounts of tackifier resins, if used, may comprise, for example, from about 0.5 to about 10 phr, usually about 1 to about 5 phr. Typical amounts of processing aids, if used, may comprise, for example, from about 1 to up to about perhaps 50 phr depending somewhat upon the processing aid and intended properties of the rubber composition. Such processing aids may include, for example, aromatic, napthenic, and/or paraffinic processing oils. Typical amounts of antioxidants may comprise, for example, from about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, from about 1 to 5 phr. Typical amounts of fatty acids, if used, which can include stearic acid, may comprise, for example, from about 0.5 to about 3 phr. Typical amounts of zinc oxide may comprise, for example, about 1 to about 5 to 10 phr. Typical amounts of waxes, for used, may comprise, for example, about 1 to about 5 phr. Often microcrystalline waxes are used. Typical amounts of peptizers, if used, may comprise, for example, about 0.1 to about 1 phr.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging, for example, from about 0.5 to about 4 phr, or even, in some circumstances, up to about 8 phr.

Accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging from, for example, about 0.5 to about 4, often preferably from about 0.8 to about 1.5, phr. In another embodiment, combinations of a primary and a secondary accelerator might be used with the secondary accelerator being used in smaller amounts, for example, of about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are, for example, amines, disulfides, guanidines, thioureas, thiazoles, thiurams, sulfenamides, sulfenimides, dithiocarbamates and xanthates. Preferably, the primary accelerator is a sulfenamide or sulfenimide. If a second accelerator is used, the secondary accelerator is preferably, for example, a guanidine, dithiocarbamate or thiuram compound.

The presence and relative amounts of the above additives are not considered to be an aspect of the present invention, unless otherwise indicated herein, which is more primarily directed to the utilization a tin coupled amine functionalized polybutadiene elastomer in combination with a nanostructured inversion carbon black reinforcement in, for example, a tire tread rubber composition.

The mixing of the rubber composition can be accomplished by methods known to those having skill in the rubber mixing art. For example, the ingredients are typically mixed in at least two stages, namely, at least one non-productive stage (NP) followed by a productive mix stage (P). The final curatives are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art.

The following examples are presented to illustrate the invention and are not intended to be limiting. The parts and percentages are by weight unless otherwise designated.

### EXAMPLE I

A series of rubber based compositions which contained carbon black and silica reinforcement were prepared which are referred to herein as Samples A through D, with Sample A, Sample B and Sample C being comparative Control Samples.

Control Sample A contained a combination of cis 1,4-butadiene rubber and solution polymerization derived styrenelbutadiene copolymer rubber (oil extended with 37.5 parts oil per 100 parts by weight of the copolymer rubber) reinforced with classical N234 rubber reinforcing carbon black and precipitated silica, together with a coupling agent for the silica.

Control Sample B differed from Control Sample A in that it contained a combination of tin coupled amine end functionalized cis 1,4-butadiene rubber and solution polymerization derived styrene/butadiene copolymer rubber (oil extended with 37.5 parts oil per 100 parts by weight of the copolymer rubber) together with the reinforcement filler as the classical N234 rubber reinforcing carbon black and precipitated silica, together with a coupling agent for the silica.

Control Sample C differed from Control Sample A and Control Sample B in that it contained a combination of cis 1,4-butadiene rubber and solution polymerization derived styrenelbutadiene copolymer rubber (oil extended with 37.5 parts oil per 100 parts by weight of the copolymer rubber) reinforced with a nanostructured inversion carbon black instead of the classical N234 carbon black, and precipitated silica, together with a coupling agent for the silica.

Experimental Sample D differed from Control Sample A, Control Sample B and Control Sample C in that it contained a combination of tin coupled amine end functionalized cis 1,4-butadiene rubber and solution polymerization derived styrene/butadiene copolymer rubber (oil extended with 37.5 parts oil per 100 parts by weight of the copolymer rubber) together with reinforcing filler as nanostructured inversion carbon black and precipitated silica, together with a coupling agent for the silica.

Accordingly, both Control Sample C and Experimental Sample D contained a nanostructured inversion carbon black instead of the N234 classical rubber reinforcing carbon black.

Accordingly, only Experimental Sample D contained a combination of both tin coupled amine end functionalized polybutadiene elastomer and nanostructured inversion carbon black.

For this Example, in what is usually referred as a first non-productive mixing stage or procedure (NP1), the Samples were prepared by first blending rubber compounding ingredients (other than sulfur curative and vulcanization accelerators) in an internal rubber mixer for about 6 minutes to a temperature of about 160° C. at which time the mixture was dumped from the mixer, open roll milled, sheeted out, and allowed to cool to below 40° C.

The resulting mixture was than mixed in a second non-productive mixing stage in an internal rubber mixer (NP2) for about 6 minutes to a temperature of about 160° C. at which time the mixture was dumped from the mixer, open roll milled, sheeted out, and allowed to cool to below 40° C.

The resulting mixture, in which is usually referred to as a productive mixing stage of procedure (P), was then mixed with sulfur and vulcanization accelerators in an internal rubber for about 1.5 minutes to a temperature of about 115° C. at which time the resulting mixture was dumped from the mixture, open roll milled, sheeted out, and allowed to cool to below 40° C.

Compositions of the Samples are illustrated in the following Table 1.

TABLE 1

| | Samples | | | |
|---|---|---|---|---|
| | Control | Control | Control | |
| Material | A | B | C | D |
| First Non-Productive Mixing | | | | |
| Step | | | | |
| Cis 1,4-polybutadiene rubber¹ | 25 | 0 | 25 | 0 |
| Tin coupled amino functional | 0 | 25 | 0 | 25 |
| polybutadiene² | | | | |
| Solution SBR rubber³ | 75 | 75 | 75 | 75 |
| Microcrystalline waxes | 3 | 3 | 3 | 3 |
| Stearic acid⁴ | 3.5 | 3.5 | 3.5 | 3.5 |
| Silica⁵ | 40 | 40 | 40 | 40 |
| Coupling agent⁶ | 6.4 | 6.4 | 6.4 | 6.4 |
| Second Non-Productive | | | | |
| Mixing Step | | | | |
| N234 carbon black⁷ | 40 | 40 | 0 | 0 |
| Nanostructure inversion | 0 | 0 | 40 | 40 |
| carbon black⁸ | | | | |
| Processing oil⁹ | 7.5 | 7.5 | 7.5 | 7.5 |
| Productive Mixing Step | | | | |
| Sulfur | 1.3 | 1.3 | 1.3 | 1.3 |
| Accelerator(s)¹⁰ | 3.3 | 3.3 | 3.3 | 3.3 |
| Zinc oxide | 3 | 3 | 3 | 3 |

¹Obtained as Budene ™ 1207, as being oil extended but reported in terms of the rubber in the above Table, from The Goodyear Tire & Rubber Company
²Obtained as BR1250H ™ rubber, as being oil extended but reported in terms of the rubber in the above Table, from the Nippon Zeon Company
³Obtained as SLR4630 ™ rubber, as being oil extended but reported in terms of the rubber in the above Table, from the Dow Chemical Company
⁴Stearic acid and a minor amount of palmitic and lineolic acids
⁵Precipitated silica as Zeosil 1165MP ™ from the Rhodia company
⁶Composite of about a 50/50 weight ratio of carbon black and a bis(3-triethoxysilylpropyl) polysulfide having an average in a range of from about 2.2 to about 2.6 connecting sulfur atoms in its polysulfidic bridge as Si266 ™ from the Degussa Company
⁷Rubber reinforcing (classical) carbon black as N234, an ASTM designation, having and Iodine value of about 120 g/kg (ASTM D1510) and a DBP value of about 125 cc/100 g (ASTM D2414)
⁸A nanostructured inversion carbon black as Ecorax 1720 ™ from the Degussa Company understood to have a CTAB surface area of about 121 m²/g according to ASTM D3765, a particle size distribution curve with an absolute slope (AS) of less than 400,000 nm³, and a 24M4-DBP absorption value within a range of about 40 to about 140 cc/100 g
⁹Rubber processing oil as a TDAE (treated, distilled, aromatic extract) oil as Vivatec 500 ™ from H&R Chempharm
¹⁰Vulcanization accelerators of the sulfenamide and diphenyl guanidine types

Various physical properties of the Samples of Table 1 are reported in Table 2.

TABLE 2

| | Samples | | | |
|---|---|---|---|---|
| | Control | Control | Control | |
| Properties | A | B | C | D |
| Shore A Hardness (cured at | | | | |
| 160° C. for 15 minutes) | | | | |
| 23° C. (ASTMD-2240) | 67.2 | 67.9 | 65.7 | 67.3 |
| Rebound | | | | |
| 0° C. | 12.8 | 11.4 | 12.5 | 11.3 |
| 23° C. | 28.3 | 26.3 | 29.7 | 29.1 |
| 100° C. | 58.5 | 58.0 | 60.2 | 60.8 |
| Stress-strain (Zwick Ring)¹ | | | | |
| Tensile strength (MPa) | 16.5 | 17.3 | 17.5 | 16.7 |
| Elongation (%) | 449 | 456 | 453 | 425 |
| Modulus (100%), ring, (MPa) | 2.5 | 2.6 | 2.7 | 2.8 |
| Modulus (200%), ring, (MPa) | 6.4 | 6.5 | 6.9 | 7.1 |
| Modulus (300%), ring, (MPa) | 11.3 | 11.5 | 12.0 | 12.3 |
| RPA, 100° C., 1 Hz² | | | | |
| Storage modulus G′ | 2.54 | 2.73 | 2.53 | 2.59 |
| (1% strain), MPa | | | | |
| Storage modulus G′ | 1.00 | 1.05 | 1.02 | 1.06 |
| (50% strain), MPa | | | | |
| Tan delta (10% strain) | 0.146 | 0.146 | 0.133 | 0.131 |

¹See ASTM D412
²Data obtained according to Rubber Process Analyzer as RPA 2000 ™ instrument by Alpha Technologies, formerly the Flexsys Company and formerly the Monsanto Company. References to an RPA-2000 instrument may be found in the following publications: H. A. Palowski, et al, Rubber World. June 1992 and January 1997, as well as Rubber & Plastics News. April 26 and May 10, 1993.

It can be seen from Table 2 that the replacement of the cis 1,4-polybutadiene rubber of Sample A with the tin coupled amine end-functional polybutadiene elastomer for Sample B resulted in an increase in hysteresis in a sense of reduction of 0° C. rebound value (but essentially no change in the 100° C. rebound value), as compared to Sample A while substantially maintaining the remainder of the reported physical properties. This decrease in rebound value at 0C (increase in hysteresis) for Sample B is considered herein as being predictive of better wet traction for a tire having a tread of such rubber composition.

It can further be seen from Table 2 that the replacement of the rubber reinforcing carbon black of Sample A with the nanostructured inverse carbon black in Sample C resulted an reduction in hysteresis in a sense of increase of 100° C. rebound value (but essentially no change in the 0° C. rebound value), as compared to Sample A while substantially maintaining the remainder of the reported physical properties. This increase in rebound value at 100° C. (decrease in hysteresis) for Sample C is considered herein as being predictive of better (reduced) rolling resistance for a tire having a tread of such rubber composition.

It can additionally be seen from Table 2 that the placement of both the cis 1,4-polybutadiene rubber and rubber reinforcing carbon black of Sample A with the tin coupled amine end functionalized polybutadiene and the nanostructured inverse carbon black in Sample D resulted in both an increase in hysteresis in a sense of decreased 0° C. rebound value and a decrease in hysteresis in a sense of an increase in 100° C. rebound value, as compared to Sample A while substantially maintaining the remainder of the reported physical properties. This combination of decrease in rebound value at 0° C. (increase in hysteresis) and increase in rebound value at 100° C. (decrease in hysteresis) for Sample D is considered herein to be a significant discovery as being predictive of both better wet traction and better (reduced) rolling resistance for a tire having a tread of such rubber composition, particularly while substantially maintaining the remainder of the reported physical properties.

While various embodiments are disclosed herein for practicing the invention, it will be apparent to those skilled in this art that various changes and modifications may be made therein without departing from the spirit or scope of the invention.

What is claimed is:

1. A tire having a tread of a rubber composition comprised of, based upon parts by weight per 100 parts by weight of elastomer (phr),
(A) 100 phr of elastomers comprised of:
(1) about 5 to about 50 phr of polybutadiene elastomer comprised of a tin coupled amine end functionalized polybutadiene elastomer, and
(2) about 50 to about 95 phr of at least one additional conjugated diene-based elastomer selected from polymers of isoprene, copolymers of isoprene and 1,3-butadiene and copolymers of styrene and at least one of isoprene and 1,3-butadiene; and
(B) about 35 to about 120 phr of rubber reinforcing filler, wherein said reinforcing filler is comprised of nanostructured inversion carbon black.

2. The tire of claim 1 wherein said nanostructured inversion carbon black has:
(A) a particle size distribution curve with an absolute slope (AS) of less than 400,000 nm³ and greater than 100,000 nm³, the absolute slope (AS) as determined from measured aggregate size distribution using the following formula:
$$AS = \frac{{\sum }_{i = 1}^{k} {{H}_{i} ( {x}_{i} - \overline{x} )}^{3}}{{\sum }_{i = 1}^{k} {H}_{i}}$$
wherein Hᵢ denotes the frequency at which the particle diameter xᵢ occurs and x is the particle diameter of the aggregate, whose weight corresponds to the average particle weight of the carbon black aggregate, the summation being carried out in the range of 1 to 3000 nm in equidistant spacing for each nanometer,
(B) a CTAB value (ASTM D-3765) in a range of from about 20 to about 190 m²/g, and
(C) a 24M4-DBP absorption value (ASTM D-3493) in a range of from about 40 to about 140 cc/100 g.

3. The tire of claim 1 wherein said about 35 to about 120 phr of rubber reinforcing filler is comprised of:
(A) about 30 to about 100 phr of said nanostructured inversion carbon black, and
(B) about 5 to about 90 phr of at least one rubber reinforcing carbon black having a combination of Iodine adsorption value (ASTM D-1510) in a range of from about 90 to about 150 g/kg and a DBP value (ASTM D-2414) in a range of from about 100 to about 200 cc/100 g.

4. The tire of claim 1 wherein said about 35 to about 120 phr of rubber reinforcing filler is comprised of:
(A) about 5 to about 90 phr of said nanostructured inversion carbon black, and
(B) about 10 to about 85 phr of precipitated silica which contains hydroxyl groups thereon, and
(C) optionally a coupling agent for said precipitated silica having a moiety reactive with said hydroxyl groups on said precipitated silica and another different moiety interactive with said polybutadiene elastomer and said additional conjugated diene-based elastomer.

5. The tire of claim 2 wherein said about 35 to about 120 phr of rubber reinforcing filler is comprised of:
(A) about 5 to about 90 phr of said nanostructured inversion carbon black, and
(B) about 10 to about 85 phr of precipitated silica which contains hydroxyl groups thereon, and
(C) optionally a coupling agent for said precipitated silica having a moiety reactive with said hydroxyl groups on said precipitated silica and another different moiety interactive with said polybutadiene elastomer and said additional conjugated diene-based elastomer.

6. The tire of claim 1 wherein said about 35 to about 120 phr of rubber reinforcing filler is comprised of:
(A) about 35 to about 110 phr of rubber reinforcing carbon black comprised of:
(1) about 30 to about 105 phr of said nanostructured inversion carbon black, and
(2) about 5 to about 80 phr of classical rubber reinforcing carbon black having said combination of Iodine adsorption and DBP values, and
(B) about 10 to about 85 phr of said precipitated silica, and
(C) optionally a coupling agent for said precipitated silica having a moiety reactive with said hydroxyl groups on said precipitated silica and another different moiety interactive with said polybutadiene elastomer and said additional conjugated diene-based elastomer.

7. The tire of claim 2 wherein said about 35 to about 120 phr of rubber reinforcing filler is comprised of:
(A) about 35 to about 110 phr of rubber reinforcing carbon black comprised of:
(1) about 30 to about 105 phr of said nanostructured inversion carbon black, and
(2) about 5 to about 80 phr of classical rubber reinforcing carbon black having said combination of Iodine adsorption and DBP values, and
(B) about 10 to about 85 phr of said precipitated silica, and
(C) optionally a coupling agent for said precipitated silica having a moiety reactive with said hydroxyl groups on said precipitated silica and another different moiety interactive with said polybutadiene elastomer and said additional conjugated diene-based elastomer.

8. The tire of claim 1 wherein said tin-coupled amine end functionalized polybutadiene elastomer is prepared by reacting “living” amine end functionalized polybutadiene having lithium end groups with tin tetrachloride.

9. The tire of claim 2 wherein said tin-coupled amine end functionalized polybutadiene elastomer is prepared by reacting “living” amine end functionalized polybutadiene having lithium end groups with tin tetrachloride.

10. The tire of claim 3 wherein said tin-coupled amine end functionalized polybutadiene elastomer is prepared by reacting “living” amine end functionalized polybutadiene having lithium end groups with tin tetrachloride.

11. The tire of claim 1 wherein said additional conjugated diene-based elastomers are selected from at least one of natural cis 1,4-polyisoprene, synthetic cis 1,4-polyisoprene, cis 1,4-polybutadiene, styrene/butadiene copolymers, isoprene/butadiene copolymers, styrene/isoprene/butadiene terpolymers, high vinyl polybutadiene rubber containing from about 30 to about 90 percent vinyl 1,2-groups and 3,4-polyisoprene elastomer, wherein said 3,4-polyisoprene elastomer is used in a range of from about 5 about 20 phr in said rubber composition.

12. The tire of claim 3 wherein said additional conjugated diene-based elastomers are selected from at least one of natural cis 1,4-polyisoprene, synthetic cis 1,4-polyisoprene, cis 1,4-polybutadiene, styrene/butadiene copolymers, isoprene/butadiene copolymers, styrene/isoprene/butadiene terpolyrners, high vinyl polybutadiene rubber containing from about 30 to about 90 percent vinyl 1,2-groups and 3,4-polyisoprene elastomer, wherein said 3,4-polyisoprene elastomer is used in a range of from about 5 about 20 phr in said rubber composition.

13. The tire of claim 4 wherein said coupling agent is used and is:
(A) a bis-(3-trialkoxysilylalkyl) polysulfide having an average of from 2 to about 4 connecting sulfur atoms in its polysulfidic bridge, or
(B) a combination of a bis-(3-triethoxysilylpropyl) polysulfide having an average of from about 2 to about 2.6 connecting sulfur atoms in its polysulfidic bridge and a bis-(3-triethoxysilylpropyl) polysulfide having an average of from about 3.4 to about 4 connecting sulfur atoms in its polysulfidic bridge, wherein said polysulfide having an average of from 2 to about 2.6 connecting sulfur atoms in its polysulfidic bridge, to the exclusion of such polysulfide having an average of from 3 to 4 connecting sulfur atoms in its polysulfidic bridge, is blended with said rubber composition in the absence of sulfur and sulfur vulcanization accelerator and wherein said polysulfide having an average of from about 3.4 to about 4 connecting sulfur atoms in its polysulfidic bridge is thereafter blended with said rubber composition in the presence of sulfur and at least one sulfur vulcanization accelerator, or
(C) an organoalkoxymercaptosilane composition of the general Formula (I) represented as:
(X)ₙ(R⁷O)₃₋ₙ—Si—R₈—SH (I)
wherein X is a radical selected from chlorine, bromine and alkyl radicals having from one to 16 carbon atoms; wherein R⁷ is an alkyl radical having from 1 through 18 carbon atoms; wherein R₈ is an alkylene radical having from one to 16 carbon atoms, preferably a propylene radical; and n is an average value of from zero through 3, and wherein, in such cases where n is zero or 1, R⁷ may be the same or different for each (R⁷O) moiety in the composition, or
(D) an organoalkoxymercaptosilane in a form of the said organoalkoxymercaptosilane (of the general Formula I) having its mercapo moiety capped with a moiety which can uncap its mercapto group.

14. The tire of claim 4 wherein said coupling agent is used and is:
(A) a bis-(3-trialkoxysilylalkyl) polysulfide having an average of from 2 to about 4 connecting sulfur atoms in its polysulfidic bridge, or
(B) an organoalkoxymercaptosilane composition of the general Formula (I) represented as:
(X)ₙ(R⁷O)₃₋ₙ—Si—R₈—SH (I)
wherein X is a radical selected from chlorine, bromine and alkyl radicals having from one to 16 carbon atoms; wherein R⁷ is an alkyl radical having from 1 through 18 carbon atoms; wherein R₈ is an alkylene radical having from one to 16 carbon atoms, preferably a propylene radical; and n is an average value of from zero through 3, and wherein, in such cases where n is zero or 1, R⁷ may be the same or different for each (R⁷O) moiety in the composition, or
(C) an organoalkoxymercaptosilane in a form of the said organoalkoxymercaptosilane (of the general Formula I) having its mercapo moiety capped with a moiety which can uncap its mercapto group.

15. The tire of claim 6 wherein said coupling agent is used and is:
(A) a bis-(3-trialkoxysilylalkyl) polysulfide having an average of from 2 to about 4 connecting sulfur atoms in its polysulfidic bridge, or
(B) a combination of a bis-(3-triethoxysilylpropyl) polysulfide having an average of from about 2 to about 2.6 connecting sulfur atoms in its polysulfidic bridge and a bis-(3-triethoxysilylpropyl) polysulfide having an average of from about 3.4 to about 4 connecting sulfur atoms in its polysulfidic bridge, wherein said polysulfide having an average of from 2 to about 2.6 connecting sulfur atoms in its polysulfidic bridge, to the exclusion of such polysulfide having an average of from 3 to 4 connecting sulfur atoms in its polysulfidic bridge, is blended with said rubber composition in the absence of sulfur and sulfur vulcanization accelerator and wherein said polysulfide having an average of from about 3.4 to about 4 connecting sulfur atoms in its polysulfidic bridge is thereafter blended with said rubber composition in the presence of sulfur and at least one sulfur vulcanization accelerator, or
(C) an organoalkoxymercaptosilane composition of the general Formula (I) represented as:
(X)ₙ(R⁷))₃₋ₙ—Si—R₈—SH (I)
wherein X is a radical selected from chlorine, bromine and alkyl radicals having from one to 16 carbon atoms; wherein R⁷ is an alkyl radical having from 1 through 18 carbon atoms; wherein R₈ is an alkylene radical having from one to 16 carbon atoms, preferably a propylene radical; and n is an average value of from zero through 3, and wherein, in such cases where n is zero or 1, R⁷ may be the same or different for each (R⁷O) moiety in the composition, or
(D) an organoalkoxymercaptosilane in a form of the said organoalkoxymercaptosilane (of the general Formula I) having its mercapo moiety capped with a moiety which can uncap its mercapto group.

16. The tire of claim 13 wherein said organoalkoxymercaptosilane is selected from at least one of triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane.

17. The tire of claim 13 wherein said capped organoalkoxymercaptosilane a liquid 3-octanoylthio-1-propyltriethoxysilane.

18. The tire of claim 13 wherein said precipitated silica is added directly to the elastomer mixture or is added as a composite of precipitated silica and said coupling agent formed by treating a precipitated silica therewith.

19. The tire of claim 13 wherein at least a portion of said precipitated silica is pre-treated prior to addition to said elastomer(s):
(A) with an alkylsilane of the general Formula (II), or
(B) with said bis(3-triethoxysilylpropyl) polysulfide having an average of from about 2 to about 4 connecting sulfur atoms in its polysulfidic bridge, or
(C) with said organomercaptosilane of the general Formula (I), or
(D) with a combination of said alkylsilane of general Formula (I) and said bis(3-triethoxysilylpropyl) polysulfide having an average of from about 2 to about 4 connecting sulfur atoms in its polysulfidic bridge, or
(E) with a combination of said alkylsilane of general Formula (II) and said organomercaptosilane of general Formula (I);
wherein said alkylsilane of the general Formula (I) is represented as:
Xₙ—Si—R₆₍₄₋ₙ₎ (II)
wherein R₆ is an alkyl radical having from 1 to 18 carbon atoms; n is a value of from 1 through 3; X is a radical selected from the group consisting of chlorine and alkoxy groups selected from methoxy and ethoxy groups.

19. The tire of claim 15 wherein at least a portion of said precipitated silica is pre-treated prior to addition to said elastomer(s):
(A) with an alkylsilane of the general Formula (II), or
(B) with said bis(3-triethoxysilylpropyl) polysulfide having an average of from about 2 to about 4 connecting sulfur atoms in its polysulfidic bridge, or
(C) with said organomercaptosilane of the general Formula (I), or
(D) with a combination of said alkylsilane of general Formula (I) and said bis(3-triethoxysilylpropyl) polysulfide having an average of from about 2 to about 4 connecting sulfur atoms in its polysulfidic bridge, or
(E) with a combination of said alkylsilane of general Formula (II) and said organomercaptosilane of general Formula (I);
wherein said alkylsilane of the general Formula (I) is represented as:
Xₙ—Si—R₆₍₄₋ₙ₎ (II)
wherein R₆ is an alkyl radical having from 1 to 18 carbon atoms; n is a value of from 1 through 3; X is a radical selected from the group consisting of chlorine and alkoxy groups selected from methoxy and ethoxy groups.
